(19) United States
(12) Patent Application Publication
(10) Pub. No.: US 2011/0049340 A1
(43) Pub. Date: Mar. 3, 2011

(54) WAVELENGTH SPECTROSCOPY DEVICE WITH INTEGRATED FILTERS

(75) Inventors: Stephane Tisserand, Marseille (FR); Marc Hubert, Aix en Provence (FR); Laurent Roux, Marseille (FR)

(73) Assignee: SILIOS TECHNOLOGIES, Peynier (FR)

(21) Appl. No.: 12/863,731

(22) PCT Filed: Jan. 20, 2009
(86) PCT No.: PCT/FR2009/000056

§ 371 Date: Oct. 6, 2010

(30) Foreign Application Priority Data
Jan. 21, 2008 (FR) 0800281

(51) Int. Cl. G01N 21/25; G01J 3/51

(52) U.S. Cl. 250/226; 356/416

(57) ABSTRACT

The invention relates to a wavelength spectroscopy device comprising, on a substrate SUB, a filter module made up of two mirrors MIR1, MIR2 that are spaced apart by a spacer membrane SP. The filter module comprises a plurality of interference filters FP1, FP2, FP3, the thickness of said spacer membrane SP being constant for any given filter and varying from one filter to another.

The present invention relates to a wavelength spectroscopy device.

Spectrometric analysis seeks in particular to find the chemical constituents making up a medium that is solid, liquid, or gaseous. It serves to record the absorption spectrum in reflection or in transmission of the medium. The light that interacts therewith is absorbed in certain wavelength bands. This selective absorption constitutes a signature for some or all of the constituents of the medium. The wavelength range that is to be measured may be formed by radiation in the ultraviolet and/or visible and/or infrared (near, medium, or far) parts of the spectrum.

A first solution makes use of a grating spectrometer. In such an appliance, the grating acting as a filter is placed at a significant distance from the detector. Resolution is improved with increase in this distance. As a result, the appliance cannot be miniaturized if it is desired to conserve acceptable resolution. In addition, adjusting that appliance is complicated and it is difficult for it to be kept stable since it requires accurate optical alignment.

Most other spectrometers make use of at least one Fabry-Perot filter.

It is recalled that such a filter is a strip of material having parallel faces (and usually having a refractive index that is low such as air, silica, . . . ) and referred to as a spacer membrane, or even “spacer” for short, the membrane appearing between two mirrors. It is often made by depositing thin layers under a vacuum. Thus, for a filter having its passband centered on a center wavelength λ, the first mirror comprises m alternating layers of optical thickness λ/4 of a material H having a high index and of a material B having a low index. The spacer membrane frequently comprises two layers of low index material B having an optical thickness λ/4. In general, the second mirror is symmetrical to the first. Modifying the geometrical thickness of the spacer membrane enables the filter to be tuned to the center wavelength for which the optical thickness is equal to a multiple of λ/2.

Under certain circumstances, a finite number of relatively fine passbands (i.e. a spectrum that is discrete as contrasted with a spectrum that is continuous) suffices to identify the looked-for constituents, such that the first above-mentioned solution is not optimal.

A second known solution provides a filter module comprising one filter per band to be analyzed. If the number of bands is n, then making n filters requires n distinct fabrication operations involving vacuum deposition. This makes the cost very high for short runs (and almost proportional to the number n of bands), and becomes of genuine advantage only for runs of sufficient length. Furthermore, the possibilities for miniaturization continue to be very limited and it is difficult to envisage providing a large number of filters.

A third known solution consists in implementing a Fabry-Perot type filter module, in which the two mirrors are not parallel but are arranged in a wedge shape for its profile in a plane perpendicular to the substrate. In this plane referenced Oxy, the axes Ox and Oy being respectively colinear with and perpendicular to the substrate, the thickness along Oy of the spacer membrane varies linearly as a function of the position along Ox where the thickness is measured.

Document U.S. 2006/0209413 teaches a wavelength spectroscopy device including such a filter module. It follows that the tuning wavelength varies continuously along the axis Ox. Firstly, controlling the “thin layer” method is very tricky under such circumstances. Secondly, collectively fabricating a plurality of filter modules on a common wafer leads to great difficulties in terms of reproducibility from one filter to another. Thirdly, the continuous variation in thickness that may present an advantage under certain circumstances is poorly adapted to a detector that needs to be centered on a very accurate wavelength. The size of the detector means that it detects all wavelengths between those on which its two ends are tuned. Once more, mass production at low cost is not very realistic.

An object of the present invention is to thus to provide a wavelength spectroscopy device enabling a spectrum to be measured in transmission or in reflection, the device being made up of a finite number of filters, and presenting great mechanical simplicity, and as a result presenting cost that is more limited.

According to the invention, a wavelength spectroscopy device comprises, on a substrate, a filter module made up of two mirrors that are spaced apart by a spacer membrane; furthermore, the filter module has a plurality of interference filters, the thickness of said spacer membrane being constant for any given filter and varying from one filter to another.

The number of operations performed in thin film technology is thus considerably reduced and there is no need to assemble different filters onto a common support.

Advantageously, at least one of said filters has a bandpass transfer function.

Furthermore, at least some of said filters are in alignment in a first strip.

In addition, at least some of said filters are in alignment in a second strip parallel to the first and disjoint therefrom.

Furthermore, at least two of said filters that are adjacent are separated by a cross-talk barrier.

Preferably, the device also includes a detector having a plurality of compartments, each active compartment being dedicated to one of said filters and being optically in alignment therewith to detect the radiation it emits by means of at least one detector cell.

Furthermore, the compartment has a plurality of detector cells and the device includes means for producing a signal by combining the output signals from said cells.

Preferably, said detector is integrated using CMOS technology.

In a first option, said substrate is constituted by an interface appearing on said detector.

In another option, the device includes imaging optics for matching the size of said filters to the size of said detector.

The present invention appears in greater detail from the following description of an embodiment given by way of illustration and with reference to the accompanying figures, in which:

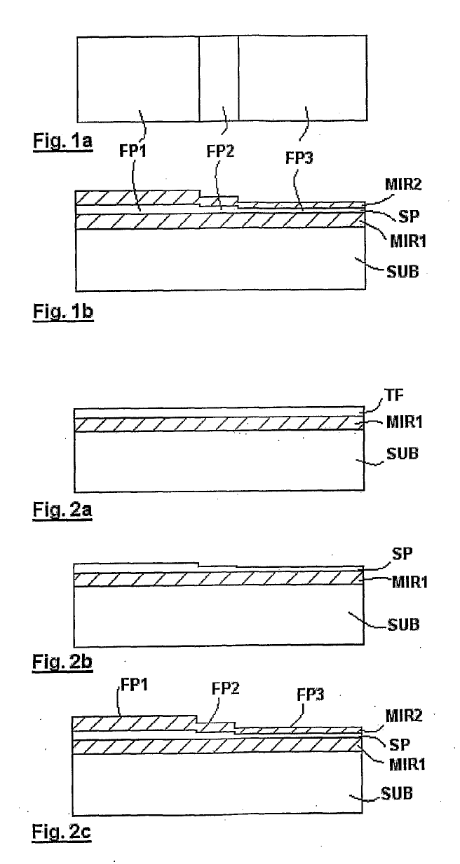

FIG. 1 is a diagram showing the principle of a one-dimensional filter module, and more particularly:

FIG. 1a is a plan view of the module; and

FIG. 1b is a section view of the module;

FIGS. 2a to 2c show three steps in making a first embodiment of the filter module;

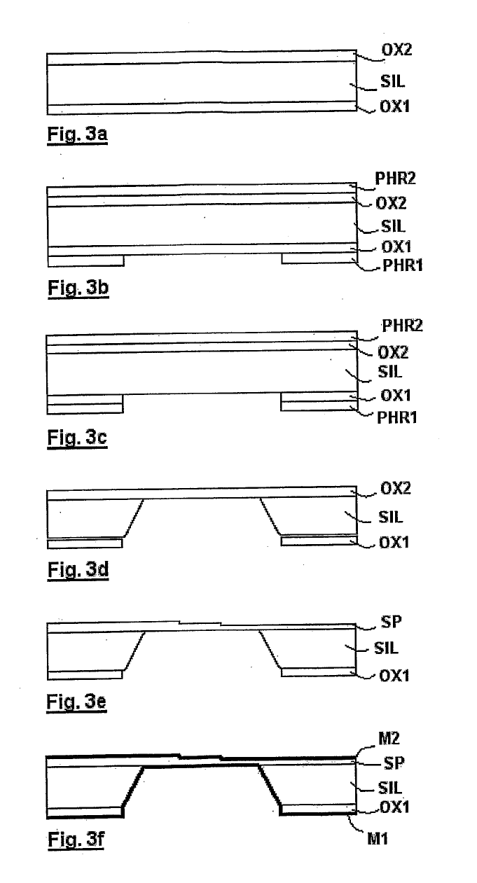

FIGS. 3a to FIG. 3f show six steps in making a second embodiment of the filter module;

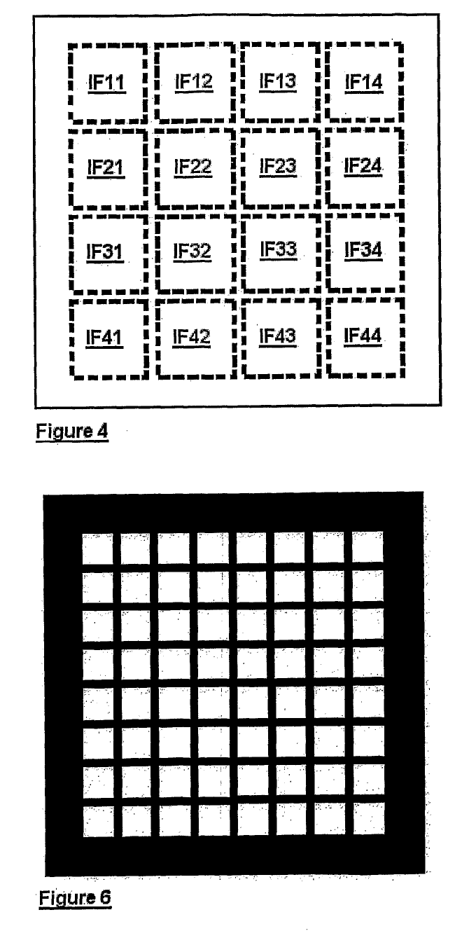

FIG. 4 is a diagram showing the principle of a two-dimensional filter module;

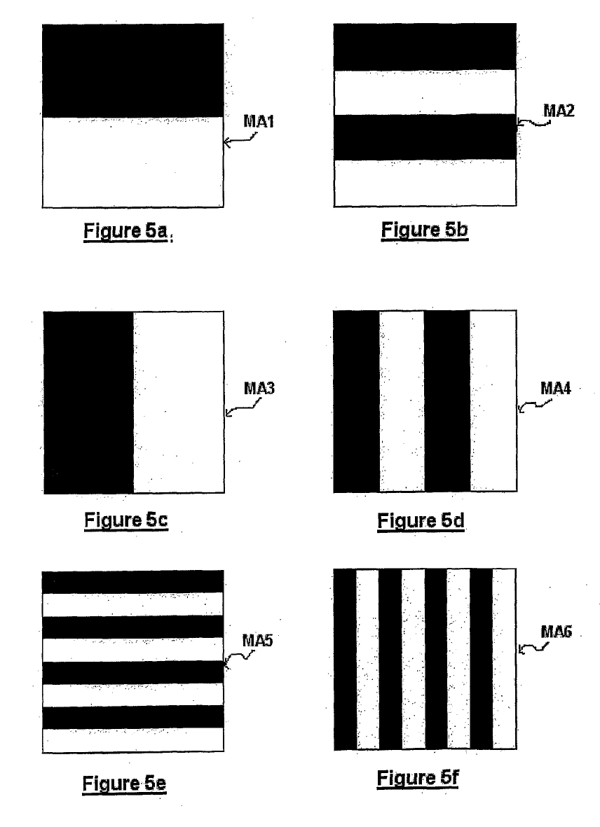

FIGS. 5a to 5f show respective masks that are suitable for being used during an etching step;

FIG. 6 is a diagram of a filter module having 64 filters and provided with a shielding grid;

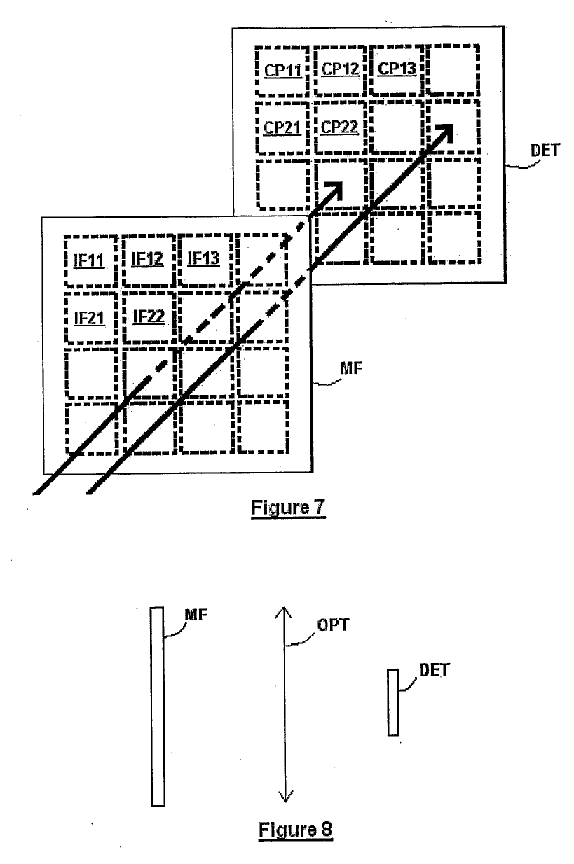

FIG. 7 is a diagram of a spectroscopy device including a filter module directly associated with a detector; and

FIG. 8 is a diagram of a spectroscopy device including a filter module associated with a detector via imaging optics.

Elements present in more than one of the figures are given the same references in each of them.

With reference to FIGS. 1a and 1b, a filter module has three Fabry-Perot interference filters FP1, FP2, and FP3 that are aligned in succession so as to form a strip.

The module is constituted by a stack on a substrate SUB made of glass or silica, for example, the stack comprising a first mirror MIR1, a spacer membrane SP, and a second mirror MIR2.

The spacer membrane SP which defines the center wavelength of each filter is thus constant for a given filter and varies from one filter to another. Its profile is staircase-shaped since each filter has a surface that is substantially rectangular.

A first method of making the filter module using thin layer technology is given by way of example.

With reference to FIG. 2a, the first mirror MIR1 is initially deposited on the substrate SUB followed by a dielectric layer or a set of dielectric layers TF to define the spacer membrane SP.

With reference to FIG. 2b, this dielectric is etched:
initially in register with the second and third filters FP2 and FP3 to define the thickness of the spacer membrane SP in the second filter FP2; and
subsequently, in the third filter FP3, to define the level of the thickness of the membrane therein.

The spacer membrane SP in the first filter FP1 has the thickness of the deposit.

With reference to FIG. 2c, the second mirror MIR2 is deposited on the spacer membrane SP in order to finish off all three filters.

The spacer membrane SP may be obtained by depositing a dielectric TF followed by successive etching operations as described above, however it can also be obtained by a plurality of successive operations of depositing thin layers.

For example, it is possible to scan the wavelength length 800 nanometers (nm) to 1000 nm by modifying the optical thickness of the spacer membrane from 1.4 λ₀/2 to 2.6 λ₀/2 (for λ₀=900 nm and n=1.45 while e varies over the range 217 nm to 403 nm).

It should be observed at this point that the thickness of the spacer membrane needs to be small enough to obtain only one transmission band in the probe domain. The more this thickness is increased, the greater the number of wavelengths that satisfy the condition [ne=kλ/2].

A second method of making the filter module is described below.

With reference to FIG. 3a, thermal oxidation is initially performed on a substrate SIL of silicon on its bottom face OX1 and on its top face OX2.

With reference to FIG. 3b, the bottom and top faces OX1 and OX2 of the substrate are covered respectively in a bottom layer PHR1 and a top layer PHR2 of photosensitive resin. Thereafter, a rectangular opening is formed in the bottom layer PHR1 by photolithography.

With reference to FIG. 3c, the thermal oxide of the bottom face OX1 is etched in register with the rectangular opening formed in the bottom layer PHR1. The bottom and top layers PHR1 and PHR2 are then removed. With reference to FIG. 3d, anisotropic etching is performed in the substrate SIL (crystallographic orientation 1-0-0 for example) in register with the rectangular opening, with the thermal oxide of the bottom face OX1 acting as a mask and with the thermal oxide of the top face OX2 acting as an etching top layer. It is possible to perform either wet etching using a potassium hydroxide (KOH) solution or a trimethyl ammonium hydroxyl (TMAH) solution, or else to perform dry etching with a plasma. This operation leaves only the bottom of the rectangular opening in the form of an oxide membrane.

With reference to FIG. 3e, this oxide is etched:
initially in the second and third filters FP2 and FP3 to define the thickness of the spacer membrane SP in the second filter FP2; and
subsequently in the third filter FP3 to define the thickness of said membrane SP therein.

With reference to FIG. 3f, the first and second mirrors M1 and M2 are deposited on the bottom and top faces OX1 and OX2 of the substrate SIL.

The filter module may possibly be finished off by depositing a passivation layer (not shown) on one and/or on the other of the bottom and top faces OX1 and OX2.

The invention thus makes it possible to produce a set of filters in alignment, the filters thus being suitable for being referenced in a one-dimensional space.

With reference to FIG. 4, the invention also makes it possible to organize such filters in two-dimensional space. Such an organization is frequently referred to as being a matrix organization.

Each of four identical horizontal strips has four interference filters. The first strip, appearing at the top of the figure, corresponds to the first row of a matrix and has filters IF11 to IF14. The second, third, and fourth strips comprise filters IF21 to IF24, filters IF31 to IF34, and filters IF41 to IF44, respectively.

The organization is said to be a matrix since the filter IFjk belongs to the j^{th} horizontal strip and also to the k^{th} vertical strip comprising the filters IF1k, IF2k, . . . , IF4k.

The method of making the filter module may be analogous to either of the two methods described above.

Thus, the first mirror and then a dielectric are deposited on the substrate. The dielectric is etched:
with reference to FIG. 5a, by means of a first mask MA1 that hides first two horizontal strips IF11-IF14 and IF21-IF24;
with reference to FIG. 5b, by means of a second mask MA2 that hides the first and third horizontal strips IF11-IF14 and IF31-IF34;
with reference to FIG. 5c, by means of a third mask MA3 that hides the first and second vertical strips IF11-IF41 and IF12-IF42; and
with reference to FIG. 5d, by means of a fourth mask MA4 that hides the first and third vertical strips IF11-IF41 and IF13-IF43.

Thereafter, the second mirror is deposited on the spacer membrane as etched in this way in order to finish off the 16 filters of the 4-by-4 matrix.

Etching to the same depth for each of the various masks is of little interest. However, it if is desired to obtain a regular progress in filter thicknesses, it is possible to proceed as follows:
etch to a depth p using the fourth mask MA4;
etch to a depth 2p using the third mask MA3;
etch to a depth 4p using the second mask MA2; and
etch to a depth 8p using the first mask MA1.

It may also be observed, that it is possible by an iterative process to use a fifth mask MA5 as shown in FIG. 5e and a sixth mask MA6 as shown in FIG. 5f to transform the above-mentioned 4-by-4 matrix into an 8-by-8 matrix having 64 interference filters.

The fifth mask MA5 follows on logically from the first and second masks MA1 and MA2, representing four horizontal black strip-white strip pairs in alternation.

Likewise, the sixth mask MA6 follows on logically from the third and fourth masks MA3 and MA4, representing four vertical black strip-white strip pairs in alternation.

With reference to FIG. 6, it is desirable to ensure that the various filters of the filter module are well separated in order to avoid partial overlap between a filter and an adjacent filter, and in order to minimize any potential problem of cross-talk. To do this, it is possible to add a grid (in black in the figure) on the filter module so as to constitute a cross-talk barrier in order to define all of the filters. The grid is absorbent if the module is used in reflection or else reflective if it is used in transmission. By way of example, an absorbent grid may be made by depositing and etching black chromium (chromium plus chromium oxide), while a reflecting grid may be made by depositing and etching chromium.

As an indication, the dimension of the filters is of the order of 300 micrometers (μm) by 300 μm. Nevertheless, other filter sizes are naturally possible, and the size must be sufficient to avoid excessive diffraction phenomena.

The filter module may present an organization of these filters as a row, a matrix, hexagonally, or in any other way. The filters may be of arbitrary shape (square, rectangular, hexagonal, . . . ).

The filter module is designed to be associated with a detector suitable for measuring the light fluxes produced by at least some of the filters, if not all of them. The detector is thus made up of a plurality of compartments, each active compartment being dedicated to a specific filter.

According to an additional characteristic of the invention, the detector is integrated in the filter. When the working radiation lies in the range 350 nm to 1100 nm, the detector is preferably made using complementary metal-oxide-on-silicon (CMOS) technology. With reference to FIG. 7, there can be seen the filter module MF as shown in FIG. 4 and used in transmission. It is optically in alignment with a detector DET having compartments that are geometrically similar to the filters. Thus, the first, second, and third compartments CP11, CP12, CP13 are designed to receive the light fluxes transmitted by the first, second, and third filters IF11, IF12, and IF13 respectively. More generally, the compartment CPjk forming part of the j^{th} row and the k^{th} column of the detector DET receives the radiation that is transmitted by the filter IFjk forming part of the j^{th} row and the k^{th} column of the filter module MF. Advantageously, a compartment is provided with a plurality of independent detector cells since these cells are commonly of a size of the order of 6 μm. Means are then provided to produce a signal estimating the light flux received by the compartment by combining the signals output by the various cells. It is thus possible to average these output signals, to eliminate any signals that depart significantly from the average, or to perform any other processing known to the person skilled in the art.

Assembly is very simple since there are few optical components and there are no moving parts. Measurement is consequently very stable and very reproducible.

Assembly may even be eliminated if the filter module is integrated directly on an interface of the detector. This interface may be a passivation layer or it may be directly the top face of the detector.

With reference to FIG. 8, the spectroscopy device includes imaging optics OPT such as an objective lens arranged between the filter module MF and the detector DET. The purpose of such optics is to match the size of the filter module MF to the size of the detector DET. It may perform magnification or reduction. If it reduces image size, then the light flux received by the detector is increased in the ratio of the area of the filter module to the area of the detector.

The embodiments of the invention described above have been selected because of their concrete nature. Nevertheless, it is not possible to list exhaustively all possible embodiments covered by the invention. In particular, any of the means described may be replaced by equivalent means without going beyond the ambit of the present invention.

1. A wavelength spectroscopy device comprising, on a substrate (SUB), a filter module made up of two mirrors (MIR1, MIR2; M1, M2) that are spaced apart by a spacer membrane (SP), the device being characterized in that the filter module has a plurality of interference filters (FP1, FP2, FP3; IF11-IF44), the thickness of said spacer membrane (SP) being constant for any given filter and varying from one filter to another.

2. A device according to claim 1, characterized in that at least one of said filters (FP1, FP2, FP3; IF11-IF44) has a bandpass transfer function.

3. A device according to claim 1, characterized in that at least some of said filters (FP1, FP2, FP3; IF11-IF14) are in alignment in a first strip.

4. A device according to claim 3, characterized in that at least some of said filters (IF21-IF24) are in alignment in a second strip parallel to the first and disjoint therefrom.

5. A device according to claim 1, characterized in that at least two of said filters (FP1, FP2, FP3; IF11-IF44) that are adjacent are separated by a cross-talk barrier.

6. A device according to claim 1, characterized in that it also includes a detector (DET) having a plurality of compartments (CP11-CP44), each active compartment being dedicated to one of said filters (FP1, FP2, FP3; IF11-IF44) and being optically in alignment therewith to detect the radiation it emits by means of at least one detector cell.

7. A device according to claim 6, characterized in that the compartment (CP11-CP44) has a plurality of detector cells and the device includes means for producing a signal by combining the output signals from said cells.

8. A device according to claim 6, characterized in that said detector (DET) is integrated using CMOS technology.

9. A device according to claim 8, characterized in that said substrate is constituted by an interface appearing on said detector (DET).

10. A device according to claim 8, characterized in that it includes imaging optics (OPT) for matching the size of said filters (FP1, FP2, FP3; IF11-IF44) to the size of said detector (DET).
